(19) United States
(12) Patent Application Publication
(10) Pub. No.: US 2026/0281503 A1
(43) Pub. Date: Sep. 17, 2026

(54) METHOD, APPARATUS, DEVICE AND STORAGE MEDIUM FOR INTERFACE INTERACTION

(71) Applicant: Beijing Zitiao Network Technology Co., Ltd., Beijing (CN)

(72) Inventors: Yu CUI, Beijing (CN); Ziwei LI, Beijing (CN); Jun LIU, Beijing (CN); Shang LUO, Beijing (CN); Peng ZHANG, Beijing (CN); Hanqing WANG, Beijing (CN); Wenshu ZHANG, Beijing (CN)

(21) Appl. No.: 19/469,178

(22) PCT Filed: Oct. 16, 2024
(86) PCT No.: PCT/CN2024/125347

§ 371 Date: Sep. 25, 2025

(30) Foreign Application Priority Data
Dec. 1, 2023 (CN) 202311641176.0

(51) Int. Cl. H04N 21/466; H04N 21/431; H04N 21/472

(52) U.S. Cl. CPC H04N 21/4668; H04N 21/4316; H04N 21/47217

(57) ABSTRACT

Embodiments of the invention relates to a method, apparatus, device and storage medium for interface interaction. The method provided includes: displaying a target interaction area in a playback interface of a first work, the target interaction area displaying a first content and at least one candidate item associated with the first content, where the first content or the at least one candidate item represents a work topic associated with the first work; and receiving a selection by a user for a target candidate item in the at least one candidate item, the selection configured to express feedback from the user with respect to the first work. In this way, the embodiments of the present disclosure can adjust the recommended content for the user by obtaining the confirmation of the user about prompts.

This application claims the benefits of Chinese Patent Application No. 202311641176.0, filed on Dec. 1, 2023, entitled “Method, Apparatus, Device and Storage Medium for Interface Interaction”, the entire content of which is incorporated herein by reference.

### FIELD

Example embodiments of the present disclosure generally relate to the field of computers, and in particular, to a method, apparatus, device, and computer-readable storage medium for interface interaction.

### BACKGROUND

With the development of computer technologies, the Internet has become an important source for people to obtain various contents. People can obtain various types of works, for example, video works, picture works, music works, and the like through work sharing applications. How to provide users with works of interest has always been a focus of people's attention.

### SUMMARY

In a first aspect of the present disclosure, a method for interface interaction is provided. The method includes: displaying a target interaction area in a playback interface of a first work, the target interaction area displaying first content and at least one candidate item associated with the first content, where the first content or the at least one candidate item represents a work topic associated with the first work; and receiving a selection by a user for a target candidate item in the at least one candidate item, the selection configured to express feedback from the user with respect to the first work.

In a second aspect of the present disclosure, a method for interface interaction is provided. The method includes: displaying a playback interface of a target work; and displaying a dialog window with a digital object based on a second preset operation associated with the playback interface, the dialog window configured to obtain dialog input from a user to adjust the recommended content for the user.

In a third aspect of the present disclosure, an apparatus for interface interaction is provided. The apparatus includes: a first display module configured to display a target interaction area in a playback interface of a first work, the target interaction area displaying a first content and at least one candidate item associated with the first content, where the first content or the at least one candidate item representing a work topic associated with the first work; and a first receiving module configured to receive a selection by a user for a target candidate item in the at least one candidate item, the selection configured to express feedback from the user with respect to a work recommendation.

In a fourth aspect of the present disclosure, an apparatus for interface interaction is provided. The apparatus includes: a second display module configured to display a playback interface of a target work; and a third display module configured to display a dialog window with a digital object based on a second preset operation associated with the playback interface, the dialog window configured to obtain dialog input from the user to adjust the recommended content for the user.

In a fifth aspect of the present disclosure, an electronic device is provided. The apparatus includes at least one processing unit; and at least one memory coupled to the at least one processing unit and storing instructions for execution by the at least one processing unit. The instructions, when executed by the at least one processing unit, cause the device to perform the method of the first aspect or the second aspect.

In a sixth aspect of the present disclosure, a computer-readable storage medium is provided. The computer-readable storage medium has stored thereon a computer program executable by the processor to implement the method of the first aspect or the second aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numerals refer to the same or similar elements, in which:

FIG. 1 illustrates a schematic diagram of an example environment in which embodiments according to the present disclosure may be implemented;

FIGS. 2A to 2C illustrate example interfaces according to some embodiments of the present disclosure;

FIGS. 3A to 3B illustrate example interfaces according to further embodiments of the present disclosure;

FIGS. 4A to 4C illustrate example interfaces according to still further embodiments of the present disclosure;

FIG. 5A and FIG. 5B illustrate flowcharts of example interface interaction processes according to some embodiments of the present disclosure;

FIG. 6A and FIG. 6B illustrate a schematic structural block diagram of an apparatus for interface interaction according to some embodiments of the present disclosure; and

FIG. 7 illustrates a block diagram of an electronic device capable of implementing multiple embodiments of the present disclosure.

### DETAILED DESCRIPTION

Embodiments of the present disclosure will be described in more detail below with reference to the accompanying drawings. While certain embodiments of the present disclosure are illustrated in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “comprising/including” and the like should be understood to be open-ended, that is, “comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be comprised below. The terms “first,” “second,” and the like may refer to different or identical objects. Other explicit and implicit definitions may also be comprised below.

Embodiments of the present disclosure may relate to data of a user, obtaining and/or use of data, and the like. These aspects all follow the corresponding laws and regulations and relevant provisions. In the embodiments of the present disclosure, collection, obtaining, handling, processing, forwarding, use and the like of all data are performed on the basis that the user knows and confirms. Accordingly, when implementing the embodiments of the present disclosure, the types of the data or information that may be involved, the scope of use, the usage scenario, and the like should be notified to the user and the authorization of the user is obtained in an appropriate manner according to the relevant laws and regulations. The specific methods for notification and/or authorization may vary according to actual situations and application scenarios, and the scope of the present disclosure is not limited in this respect.

In the present specification and solutions in the embodiments, if personal information processing is involved, processing may be performed on the basis of legitimacy (e.g., obtaining the consent of a personal information subject, or as necessary for the performance of a contract), and processing is only within a scope stipulated or agreed upon. The user's refusal to allow processing of personal information not necessary for the basic functions does not affect the use of the basic function by the user.

As briefly mentioned above, people expect to be able to obtain works of interest more efficiently. Some conventional solutions may, for example, provide a configuration interface to a user, and display a plurality of work topics. The user may, for example, select from these work topics that are of interest or not of interest. However, such fixed work topics are difficult to satisfy the personalized adjustment requirements of users.

In view of this, embodiments of the present disclosure provide an interface interaction solution. According to the solution, a target interaction area can be displayed in a playback interface of a first work, the target interaction area displaying first content and at least one candidate item associated with the first content, where the first content or the at least one candidate item represents a work topic associated with the first work. Further, a selection by a user for a target candidate item in the at least one candidate item may be received, the selection configured to express feedback from the user with respect to the first work.

In this way, according to the embodiments of the present disclosure, a recommended content for the user can be adjusted by obtaining the user's confirmation about a prompt. In addition, by presenting such prompts in association with the work playback page, embodiments of the present disclosure can improve the user's perception of related work topics and improve the engagement of the user in providing feedback.

Various example implementations of this solution are described in detail below in conjunction with the accompanying drawings.

### Example Environment

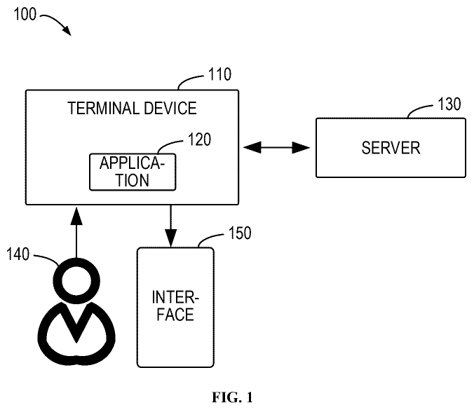

FIG. 1 illustrates a schematic diagram of an example environment 100 in which embodiments of the present disclosure can be implemented. As shown in FIG. 1, the example environment 100 may include a terminal device 110.

In this example environment 100, an application 120 for providing and viewing media content may run on the terminal device 110. The application 120 may be any suitable type of application for sharing works or obtaining works, examples of which may include, but are not limited to: online video applications, live streaming applications. The user 140 may interact with the application 120 via the terminal device 110 and/or its attachment device. In the environment 100 of FIG. 1, if the application 120 is active, the terminal device 110 may present an interface 150 through the application 120.

In some embodiments, the terminal device 110 communicates with a server 130 to enable provisioning of services for the application 120. The terminal device 110 may be any type of a mobile terminal, a fixed terminal, or a portable terminal, including a mobile phone, a desktop computer, a laptop computer, a notebook computer, a netbook computer, a tablet computer, a media computer, a multimedia tablet, a palm computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination thereof, accessories and peripherals including these devices, or any combination thereof. In some embodiments, the terminal device 110 can also support any type of interface for a user (such as a “wearable” circuit, etc.).

The server 130 may be an independent physical server, it may also be a server cluster composed of multiple physical servers, or a distributed system, and it may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for the application 120 that supports a virtual scene in the terminal device 110.

A communication connection may be established between the server 130 and the terminal device 110. The communication connection may be established in a wired manner or a wireless manner. The communication connection may include, but is not limited to, a Bluetooth connection, a mobile network connection, a universal serial bus (USB) connection, a wireless fidelity (Wi-Fi) connection, and the like, and the embodiments of the present disclosure are not limited in this aspect. In an embodiment of the present disclosure, the server 130 and the terminal device 110 may implement signaling interaction by using a communication connection between the server 130 and the terminal device 110.

It should be understood that the structures and functions of the various elements in the environment 100 are described for illustrative purposes only without implying any limitation on the scope of the present disclosure.

Some example embodiments of the present disclosure will be described below with continued reference to the accompanying drawings.

### Example Scenario One

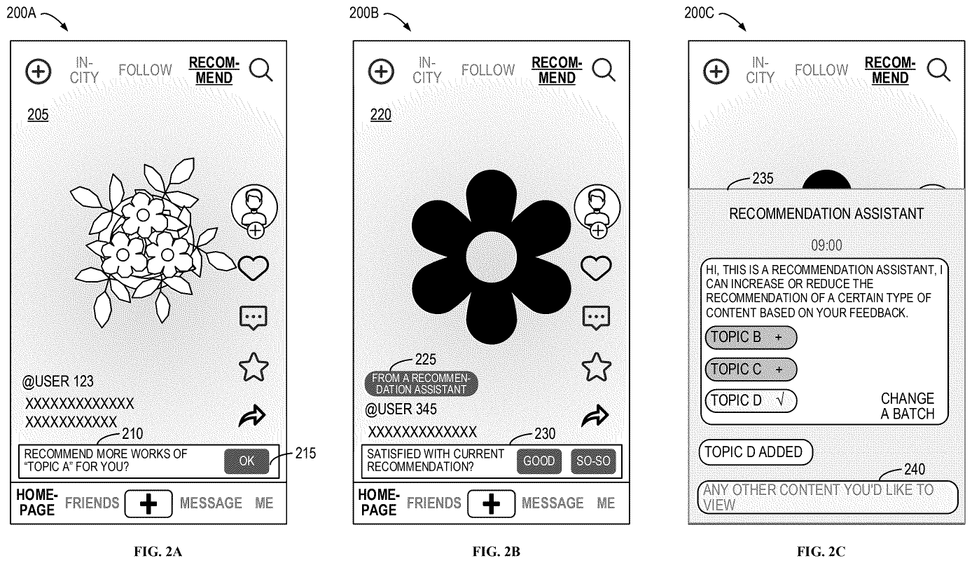

Example interactions of some embodiments of the present disclosure are described below with reference to FIGS. 2A to 2C. FIGS. 2A to 2C illustrate example interfaces 200A to 200C according to some embodiments of the present disclosure, for example, the example interfaces 200A to 200C may be provided by the terminal device 110 shown in FIG. 1.

As shown in FIG. 2A, the terminal device 110 may provide an interface 200A. The interface 200A is a playback interface of work 205.

In some embodiments, as shown in FIG. 2A, the interface 200A may display a target interaction area 210 (which may also be referred to as an interaction window, interaction control, or the like). The target interaction area 210 may include, for example, a query content, for example, “Recommend more works of ”topic A“ for you?”. In addition, the target interaction area 210 may also include a candidate item 215.

In some embodiments, the query content may represent a work topic associated with the work 205, such as “topic A”. In some embodiments, the work topic associated with the work 205 may be determined based on the category of the work 205.

As yet another example, the work 205 may be processed using any appropriate model to determine its corresponding work topic. Such a model may be implemented, for example, using an appropriate machine learning model, e.g., a language model.

In the example of FIG. 2A, a query statement may be used to solicit feedback from the user with respect to the work 205, e.g., feedback with respect to whether to increase the recommended content associated with the topic. In still other examples, the query statement may also be used, for example, to solicit feedback from the user on whether to reduce the recommended content associated with the topic.

In some embodiments, the target interaction area 210 may be presented accordingly, for example, based on the playback interface 200A being displayed. For example, the target interaction area 210 may be presented as the playback interface 200A is loaded. In some embodiments, when the target interaction area 210 includes a query statement for soliciting feedback from the user on whether to reduce the recommended content associated with the topic, the target interaction area 210 may be presented accordingly in response to the playback interface 200A being displayed.

In some embodiments, the target interaction area 210 may also be presented after the work 205 is played for a preset duration. For example, after the work 205 is played for X seconds, the target interaction area 210 may be displayed in the playback interface 200A. In some embodiments, when the target interaction area 210 includes a query statement for soliciting feedback from the user on whether to increase the recommended content associated with the topic, the target interaction area 210 may be presented after the work 205 is played for the preset duration.

In some embodiments, if no preset operation on the target interaction area 210 is received within a predetermined period, the terminal device 110 may stop displaying the target interaction area 210.

In still other embodiments, only if the work 205 matches a preset condition, the terminal device 110 displays the target interaction area 210 in the playback interface 200A of the work 205. In some embodiments, such a preset condition may be related to historical interaction actions of the user, for example.

For example, if the duration that the user views a specific category of works within a predetermined period is below a threshold and the work 205 matches the specific category, the terminal device 110 may display the target interaction area 210, and the target interaction area 210 may include a query statement for soliciting feedback from the user on whether to reduce the recommended content associated with the topic.

As another example, if the number of times that the user searches for a specific category of works within a predetermined period is greater than a threshold, the terminal device 110 may display the target interaction area 210, and the target interaction area 210 may include a query statement for soliciting feedback from the user on whether to increase the recommended content associated with the topic.

It should be understood that the information of historical interaction actions of the user is obtained only with knowledge of and permission from the user.

With continued reference to FIG. 2A, if the user selects a candidate item 215, the terminal device 110 may, for example, determine the feedback with respect to the work 205 expressed by the selection, that is, increasing the recommended content associated with the “Topic A”. Accordingly, the terminal device 110 may trigger an adjustment of the recommendation related to the user, thereby increasing the recommended content associated with the “Topic A”.

Further, FIG. 2B illustrates a playback interface 200B of work 220. As an example, the work 220 may be, for example, related to the “Topic A”, and may be recommended based on the user's triggering with respect to the candidate item 215.

As shown in FIG. 2B, in the interface 200B, the terminal device 110 may display a prompt element 225, which may be configured to represent that the work 220 is recommended based on the feedback from the user via the target interaction area 210.

In some embodiments, the terminal device 110 may also display a feedback area 230 in the interface 200B, the feedback area 230 including at least one interaction item. The at least one interaction item may be configured to represent the candidate feedback from the user with respect to the recommended work 220, e.g., “good” or “so-so”. For example, if the user selects “so-so”, the terminal device 110 may, for example, trigger to reduce the recommended content associated with the topic.

In still other embodiments, when a preset operation (e.g., a click operation) on the prompt element 225 is received, the terminal device 110 may also display an interface 200C as shown in FIG. 2C.

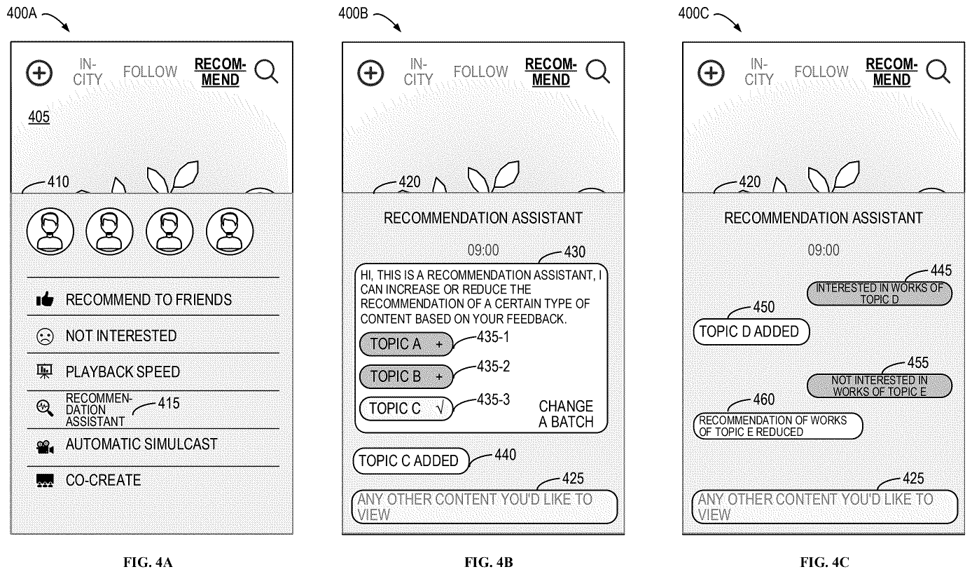

As shown in FIG. 2C, the terminal device 110 may display a dialog window 235. As will be described in detail below with reference to FIGS. 4A to 4C, the dialog window 235 may be configured to obtain dialog input from the user to adjust recommended content for the user.

Based on the process described above, according to the embodiments of the present disclosure, a more direct prompt (e.g., a work topic associated with the work) can be provided to the user in the playback interface of the work, and the recommendation feedback from the user with respect to such work topic can be obtained, thereby improving the accuracy of the work recommendation.

### Example Scenario Two

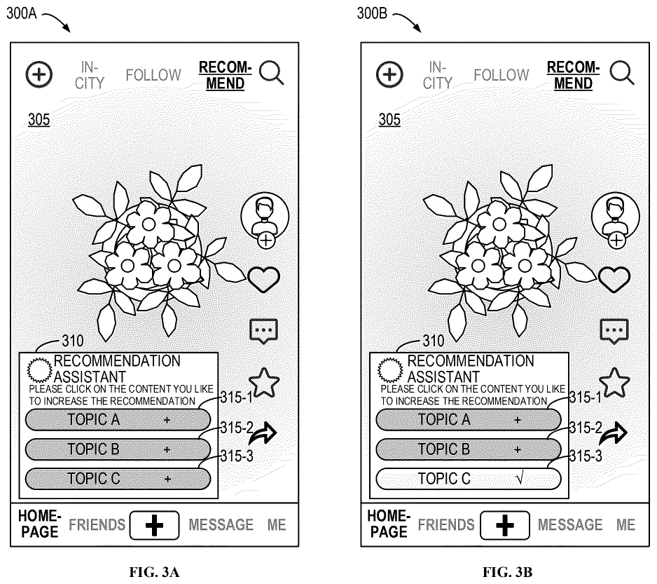

Example interactions of some embodiments of the present disclosure are described below with reference to FIGS. 3A to 3B. FIGS. 3A to 3B illustrate example interfaces 300A to 300B according to some embodiments of the present disclosure, and the example interfaces 300A to 300B may be, for example, provided by the terminal device 110 shown in FIG. 1.

As shown in FIG. 3A, the terminal device 110 may provide an interface 300A. The interface 300A is a playback interface of work 305.

In some embodiments, as shown in FIG. 3A, the interface 300A may display a target interaction area 310 (which may also be referred to as an interaction window, interaction control, or the like). For example, the target interaction area 310 may include a prompt statement, for example, “please click on a content you like to increase related recommendation”.

In addition, the target interaction area 210 may also include a plurality of candidate items 315-1, 315-2, and 315-3 (individually or collectively referred to as candidate item 315). In some embodiments, such a plurality of candidate items 315 may be configured to represent work topics associated with the work 305. For example, the candidate items 315-1 to 315-3 correspond to “Topic A”, “topic B”, and “topic C”, respectively.

In some embodiments, such a plurality of topics may also be determined based on the work 305, as discussed with reference to FIG. 2A. In some embodiments, the work topic associated with the work 305 may be determined based on the category of the work 305.

As yet another example, the work 305 may be processed using any appropriate model to determine its corresponding work topic. Such a model may be implemented, for example, using an appropriate machine learning model, such as a language model.

In some embodiments, the target interaction area 310 may be presented accordingly, for example, based on the playback interface 300A being displayed. For example, the target interaction area 310 may be presented as the playback interface 300A is loaded. In some embodiments, when the target interaction area 310 is configured to provide the user with the work topic for which recommendation is to be reduced, the target interaction area 310 may be presented accordingly in response to the playback interface 300A being displayed.

In some embodiments, the target interaction area 310 may also be presented after the work 305 is played for a preset duration. For example, after the work 305 is played for X seconds, the target interaction area 310 may be displayed in the playback interface 300A. In some embodiments, when the target interaction area 310 is configured to provide the user with the work topic for which recommendation is to be increased, the target interaction area 310 may be presented after the work 305 is played for the preset duration.

In some embodiments, if no preset operation with respect to the target interaction area 310 is received within a predetermined period, the terminal device 110 may stop displaying the target interaction area 310.

In still other embodiments, only if the work 305 matches a preset condition, the terminal device 110 displays the target interaction area 310 in the playback interface 300A of the work 305. In some embodiments, such a preset condition may be related to historical interaction actions of the user, for example. For specific preset conditions, reference may be made to the content discussed above with respect to FIG. 2A, and details are not described herein again.

As shown in FIG. 3B, the user may, for example, select the candidate item 315-3. Accordingly, the terminal device 110 may determine the feedback from the user with respect to the work 305, represented by the selection, to trigger to increase the recommended content associated with the “topic C”.

In some embodiments, similar to the description with reference to FIG. 2B and FIG. 2C, if the terminal device 110 displays the playback interface of the work recommended based on the feedback, the terminal device 110 may for example display the prompt element and/or may display a feedback area. For specific details, reference may be made to the content described above with respect to FIG. 2B and FIG. 2C, and details are not described herein again.

Based on the process described above, according to the embodiments of the present disclosure, a plurality of work topics related to the work currently played can be provided to the user in the playback interface of the work, and the recommendation feedback from the user with respect to such a work topic can be obtained, thereby improving the accuracy of the work recommendation.

### Example Scenario Three

Example interactions of some embodiments of the present disclosure are described below with reference to FIGS. 4A to 4C. FIGS. 4A to 4C illustrate example interfaces 400A to 400C according to some embodiments of the present disclosure, and the example interfaces 400A to 400C may be, for example, provided by the terminal device 110 shown in FIG. 1.

As shown in FIG. 4A, the terminal device 110 may provide an interface 400A. The interface 400A is a playback interface of work 405. In some embodiments, if a preset operation associated with the interface 400A is received (e.g., touch-and-hold of a playback area), the terminal device 110 may display a display panel 410.

In the panel 410, the terminal device 110 may, for example, provide a target entry 415. If a selection operation on the target entry 415 is received, the terminal device 110 may display an interface 400B shown in FIG. 4B.

As shown in FIG. 4B, the terminal device 110 may display a dialog window 420 with a digital assistant (e.g., a recommendation assistant). The dialog window 420 may be configured to obtain dialog input from the user, thereby triggering the adjustment of recommended content for the user.

For example, as shown in FIG. 4B, the terminal device 110 may display a first message 430 from a digital object in the dialog window 430. The first message 430 may include a set of candidate work topics 435-1, 435-2, and 435-3 (individually or collectively referred to as candidate work topic 435).

In some embodiments, such a candidate work topic 435 may be determined, for example, based on the work 405. In some embodiments, the candidate work topic 435 associated with the work 405 may be determined based on the category of the work 405.

As yet another example, the work 305 may be processed using any appropriate model to determine its corresponding candidate work topic 435. Such a model may be implemented, for example, using an appropriate machine learning model, such as a language model.

Further, the terminal device 110 may, for example, receive a selection from the user for at least one candidate work topic (e.g., the candidate work topic 435-3, i.e., the “topic C”) in the set of candidate work topics 435. Accordingly, the terminal device 110 may display a second message 440 from the digital object to indicate to increase the recommended content associated with the selected at least one candidate work topic (e.g., the candidate work topic 435-3, i.e., the “topic C”) for the user.

In some embodiments, as shown in FIG. 4B, the dialog window 420 may also include an input control 425, configured to receive a message input by the user into the dialog window.

As shown in FIG. 4C, the terminal device 110 may, for example, obtain a message 445 from the user. As an example, the message 445 may express requirements that the user expects to increase the recommended content associated with a specific work topic (e.g., “topic D”).

In some embodiments, the terminal device 110 may, for example, display the message 450 accordingly to indicate that recommended content associated with the specific work topic (e.g., the “topic D”) is increased for the user.

Specifically, the terminal device 110 and/or the server 130 may determine the requirement expressed in the received message 445 in an appropriate manner. For example, the terminal device 110 and/or the server 130 may use a language model to understand the user requirement with respect to increasing the recommended content of the “topic D”, and may accordingly trigger the server 130 to adjust the recommended content with respect to the user. In some embodiments, the message 450 may also be generated based on a language model, for example.

Additionally, the terminal device 110 may also obtain a message 455 from the user, for example. This message 455 may, for example, express requirements that the user expects to reduce the recommended content associated with a specific work topic (e.g., “topic E”).

In some embodiments, the terminal device 110 may, for example, display the message 460 accordingly to indicate that the recommended content associated with the specific work topic (e.g., the “topic E”) is reduced for the user.

Specifically, the terminal device 110 and/or the server 130 may determine the requirements expressed in the received message 455 in an appropriate manner. For example, the terminal device 110 and/or the server 130 may use a language model to understand the user requirement with respect to reduce the recommended content of the “topic E”, and may accordingly trigger the server 130 to adjust the recommended content with respect to the user. In some embodiments, the message 460 may also be generated based on a language model, for example.

In some embodiments, the dialog window 420 may also be used to query historical feedback information of the user with respect to the recommended content. For example, the user may view, through the dialog window 420, the recommended work topic that has been increased or reduced. Accordingly, the user may also cancel, for example, the increase or reduction of recommendation with respect to a specific work topic.

Based on the process described above, according to the embodiments of the present disclosure, the user can be supported to express the requirement for adjusting the recommendation by dialogs, thereby improving the efficiency of the user in adjusting the recommended content.

### Example Processes

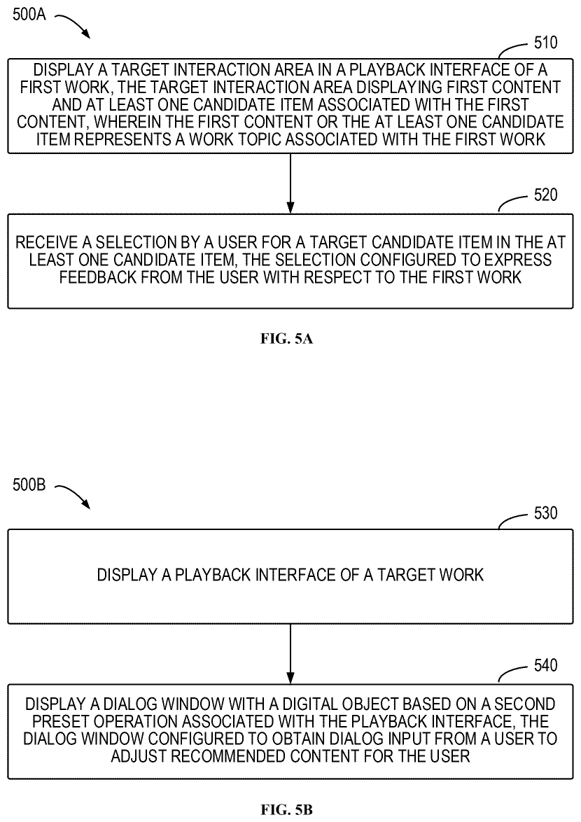

FIG. 5A illustrates a flowchart of an example interface interaction process 500A according to some embodiments of the present disclosure. The process 500A may be implemented at the terminal device 110. The process 500A is described below with reference to FIG. 1.

As shown in FIG. 5A, at block 510, the terminal device 110 displays a target interaction area in a playback interface of a first work, the target interaction area displaying first content and at least one candidate item associated with the first content, where the first content or the at least one candidate item represents a work topic associated with the first work.

At block 520, the terminal device 110 receives a selection by a user of a target candidate item in the at least one candidate item, the selection configured to express feedback from the user with respect to the first work.

In some embodiments, the first content includes: a first statement with respect to increasing recommended content associated with the work topic; or a second statement with respect to reducing recommended content associated with the work topic.

In some embodiments, the selection is configured to express the feedback from the user with respect to increasing or reducing the recommended content associated with the work topic.

In some embodiments, the at least one candidate item includes a plurality of candidate items corresponding to a plurality of work topics associated with the first work.

In some embodiments, the selection is configured to express the feedback with respect to increasing or reducing recommended content associated with a target work topic, the target candidate item corresponding to the target work topic.

In some embodiments, displaying the target interaction area in the playback interface of the first work includes: displaying the target interaction area in response to the playback interface of the first work being displayed; or displaying the target interaction area in the playback interface after the first work is played for a preset duration.

In some embodiments, displaying the target interaction area in the playback interface of the first work includes: displaying the target interaction area in the playback interface in response to the first work matching a preset condition, where the preset condition is related to a historical interaction action of the user.

In some embodiments, the playback interface is a first playback interface, and the process 500A further includes: displaying a second playback interface of a second work; and displaying an indicating element in the second playback interface, the indication element configured to represent that the second work is recommended based on the feedback from the user.

In some embodiments, the process 500A further includes: displaying a dialog window based on a first preset operation for the indication element, the dialog window configured to obtain dialog input from the user to adjust recommended content for the user.

In some embodiments, the feedback is first feedback, and the process 500A further includes: displaying at least one interaction item in the second playback interface, the at least one interaction item configured to indicate second feedback from the user with respect to the recommended second work.

FIG. 5B illustrates a flowchart of an example interface interaction process 500B according to some embodiments of the present disclosure. The process 500B may be implemented at terminal device 110. The process 500B is described below with reference to FIG. 1.

As shown in FIG. 5B, in block 530, the terminal device 110 displays a playback interface of a target work.

At block 540, the terminal device 110 displays a dialog window with a digital object based on a second preset operation associated with the playback interface, the dialog window configured to obtain dialog input from a user to adjust recommended content for the user.

In some embodiments, displaying the dialog window with the digital object based on the second preset operation associated with the playback interface includes: displaying a target entry based on a third preset operation on the playback interface; and displaying the dialog window with the digital object based on a selection operation on the target entry.

In some embodiments, the process 500B further includes: displaying a first message from the digital object in the dialog window, the first message including a set of candidate work topics; and displaying a second message from the digital object based on a selection of at least one of the set of candidate work topics, the second message indicating increasing recommended content associated with the at least one candidate work topic for the user.

In some embodiments, the set of candidate work topics is determined based on the target work.

In some embodiments, the process 500B further includes: a third message from a user in the dialog window, the third message indicating feedback from the user with respect to a specific work topic; and displaying a fourth message from the digital object, the fourth message indicating increasing or reducing recommended content associated with the specific work topic for the user.

### Example Apparatus and Device

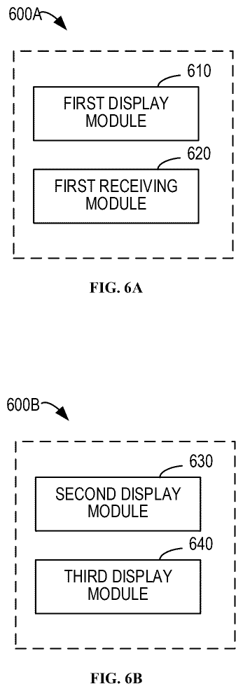

Embodiments of the present disclosure also provide a corresponding apparatus for implementing the above method or process. FIG. 6A illustrates a schematic structural block diagram of an apparatus 600A for interface interaction according to some embodiments of the present disclosure. The apparatus 600A may be implemented or included in the terminal device 110. The various modules/components in the apparatus 600A may be implemented by hardware, software, firmware, or any combination thereof.

As shown in FIG. 6A, the apparatus 600A includes a first display module 610 configured to display a target interaction area in a playback interface of a first work, the target interaction area displaying a first content and at least one candidate item associated with the first content, where the first content or the at least one candidate item representing a work topic associated with the first work; and a first receiving module 620 configured to receive a selection by a user for a target candidate item in the at least one candidate item, the selection configured to express feedback from the user with respect to the first work.

In some embodiments, the selection is configured to express the feedback from the user with respect to increasing or reducing the recommended content associated with the work topic.

In some embodiments, the at least one candidate item includes a plurality of candidate items corresponding to a plurality of work topics associated with the first work.

In some embodiments, the selection is configured to express the feedback with respect to increasing or reducing recommended content associated with a target work topic, the target candidate item corresponding to the target work topic.

In some embodiments, the first display module 610 is further configured to: display the target interaction area in response to the playback interface of the first work being displayed; or display the target interaction area in the playback interface after the first work is played for a preset duration.

In some embodiments, the first display module 610 is further configured to: display the target interaction area in the playback interface in response to the first work matching a preset condition, where the preset condition is related to a historical interaction action of the user.

In some embodiments, the playback interface is a first playback interface, and the apparatus 600A further includes a prompt module configured to: display a second playback interface of a second work; and display an indication element in the second playback interface, the indication element configured to represent that the second work is recommended based on feedback from the user.

In some embodiments, the apparatus 600A further includes a dialog module configured to: display a dialog window based on a first preset operation for the indication element, the dialog window configured to obtain dialog input from the user to adjust recommended content for the user.

In some embodiments, the feedback is first feedback, and the apparatus 600A further includes a feedback module configured to: display at least one interaction item in the second playback interface, the at least one interaction item configured to indicate second feedback from the user with respect to the recommended second work.

Embodiments of the present disclosure also provide a corresponding apparatus for implementing the above method or process. FIG. 6B illustrates a schematic structural block diagram of an apparatus 600B for interface interaction according to some embodiments of the present disclosure. The apparatus 600B may be implemented or included in the terminal device 110. The various modules/components in the apparatus 600B may be implemented by hardware, software, firmware, or any combination thereof.

As shown in FIG. 6B, the apparatus 600B includes a second display module 630 configured to display a playback interface of a target work; and a third display module 640 configured to display a dialog window with a digital object based on a second preset operation associated with the playback interface, the dialog window configured to obtain dialog input from the user to adjust recommended content for the user.

In some embodiments, the second display module 630 is further configured to: display a target entry based on a third preset operation on the playback interface; and display the dialogue window with the digital object based on a selection operation on the target entry.

In some embodiments, the apparatus 600B further includes a first interaction module configured to: display a first message from the digital object in the dialog window, the first message including a set of candidate work topics; and display a second message from the digital object based on a selection of at least one of the set of candidate work topics, the second message indicating increasing recommended content associated with the at least one candidate work topic for the user.

In some embodiments, the set of candidate work topics is determined based on the target work.

In some embodiments, the apparatus 600B further includes a second interaction module configured to: receive a third message from a user in the dialog window, the third message indicating feedback from the user with respect to a specific work topic; and displaying a fourth message from the digital object, the fourth message indicating increasing or reducing recommended content associated with the specific work topic for the user.

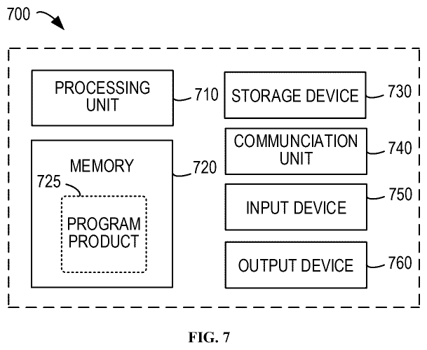

FIG. 7 illustrates a block diagram of an electronic device 700 in which one or more embodiments of the present disclosure may be implemented. It should be understood that the electronic device 700 illustrated in FIG. 7 is merely illustrative and should not constitute any limitation on the function and scope of the embodiments described herein. The electronic device 700 shown in FIG. 7 may be configured to implement the terminal device 110 in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, multiple processing units execute computer-executable instructions in parallel to improve parallel processing capabilities of electronic device 700.

The electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, a magnetic disk, or any other medium, which may be capable of storing information and/or data and may be accessed within electronic device 700.

The electronic device 700 may further include additional removable/non-removable, volatile/non-volatile storage media. Although not shown in FIG. 7, a disk drive for reading from or writing to a removable, nonvolatile magnetic disk (e.g., a “floppy disk”) and an optical disk drive for reading from or writing to a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 enables communicate with another electronic device through a communication medium. Additionally, the functionality of components of the electronic device 700 may be implemented in a single computing cluster or multiple computing machines which are capable of communication over a communication connection. Thus, the electronic device 700 may operate in a networked environment using logical connections with one or more other servers, network personal computers (PCs), or another network node.

The input device 750 may be one or more input devices, for example, a mouse, a keyboard, a trackball, or the like. The output device 760 may be one or more output devices, for example, a display, a speaker, a printer, or the like. The electronic device 700 may also communicate with one or more external devices (not shown) through the communication unit 740 as needed, the external devices such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by the processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium, these instructions cause the computer, programmable data processing apparatus, and/or other devices to function in a specific manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process, such that the instructions executed on a computer, other programmable data processing apparatus, or other apparatus implement the functions/acts specified in one or more blocks in the flowchart and/or block diagram.

The flowchart and block diagrams in the drawings show architecture, function, and operation of possible implementations of systems, methods, and computer program products according to various implementations of the present disclosure. In this regard, each block in the flowchart or block diagram may represent a module, a program segment, or a part of an instructions that includes one or more executable instructions for implementing the specified logical function. In some alternative implementations, the functions noted in the blocks may also occur in a different order than noted in the drawings. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for interface interaction comprising:
displaying an interaction area in a playback interface of a first work, the interaction area displaying first content and at least one candidate item associated with the first content, wherein the first content or the at least one candidate item represents a work topic associated with the first work; and
receiving a selection for a target candidate item in the at least one candidate item, the selection configured to indicate feedback with respect to the first work.

2. The method of claim 1, wherein the first content comprises:
a first statement with respect to increasing recommended content associated with the work topic; or
a second statement with respect to reducing recommended content associated with the work topic.

3. The method of claim 2, wherein the selection is configured to indicate the feedback with respect to increasing or reducing the recommended content associated with the work topic.

4. The method of claim 1, wherein the at least one candidate item comprises a plurality of candidates items corresponding to a plurality of work topics associated with the first work.

5. The method of claim 4, wherein the selection is configured to indicate the feedback with respect to increasing or reducing recommended content associated with a target work topic, the target candidate item corresponding to the target work topic.

6. The method of claim 1, wherein displaying the target interaction area in the playback interface of the first work comprises:
displaying the target interaction area in response to the playback interface of the first work being displayed; or
displaying the interaction area in the playback interface after the first work is played for a preset duration.

7. The method of claim 1, wherein displaying the interaction area in the playback interface of the first work comprises:
displaying the interaction area in the playback interface in response to the first work matching a preset condition, wherein the preset condition is related to a historical interaction action of a user.

8. The method of claim 1, wherein the playback interface is a first playback interface, and the method further comprises:
displaying a second playback interface of a second work; and
displaying an indication element in the second playback interface, the indication element configured to represent that the second work is recommended based on the feedback.

9. The method of claim 8, further comprising:
displaying a chat window based on a first operation for the indication element, the chat-window configured to obtain input for to adjust content recommendation.

10. The method of claim 8, wherein the feedback is first feedback, the method further comprising:
displaying at least one interaction item in the second playback interface, the at least one interaction item configured to indicate second feedback with respect to the recommended second work.

11. A method for interface interaction comprising:
displaying a playback interface of a work; and
displaying a chat window with a digital object based on a second operation associated with the playback interface, the chat window configured to obtain input to adjust content recommendation.

12. The method of claim 11, wherein displaying the chat window with the digital object based on the second operation associated with the playback interface comprises:
displaying an entry based on a third operation on the playback interface; and
displaying the chat window with the digital object based on a selection of the entry.

13. The method of claim 11, further comprising:
displaying a first message from the digital object in the chat window, the first message comprising a set of candidate work topics; and
displaying a second message from the digital object based on a selection of at least one candidate work topic among the set of candidate work topics, the second message indicating increasing recommended content associated with the at least one candidate work topic.

14. The method of claim 13, wherein the set of candidate work topics is determined based on the work.

15. The method of claim 11, further comprising:
receiving a third message from in the chat window, the third message indicating feedback with respect to a work topic; and
displaying a fourth message from the digital object, the fourth message indicating increasing or reducing recommended content associated with the work topic.

16-17. (canceled)

18. An electronic device comprising:
at least one processor; and
at least one memory coupled to the at least one processor and storing instructions for execution by the at least one processor, the instructions, when executed by the at least one processor, causing the electronic device to perform acts comprising:
displaying a interaction area in a playback interface of a first work, the interaction area displaying first content and at least one candidate item associated with the first content, wherein the first content or the at least one candidate item represents a work topic associated with the first work; and
receiving a selection by a user for a target candidate item in the at least one candidate item, the selection configured to express feedback from the user with respect to the first work.

19. (canceled)

20. The electronic device of claim 18, wherein the first content comprises:
a first statement with respect to increasing recommended content associated with the work topic; or
a second statement with respect to reducing recommended content associated with the work topic.

21. The electronic device of claim 20, wherein the selection is configured to express the feedback from the user with respect to increasing or reducing the recommended content associated with the work topic.

22. The electronic device of claim 18, wherein the at least one candidate item comprises a plurality of candidates items corresponding to a plurality of work topics associated with the first work.

23. The electronic device of claim 22, wherein the selection is configured to express the feedback with respect to increasing or reducing recommended content associated with a work topic, the target candidate item corresponding to the work topic.
